(19) United States
(12) Patent Application Publication
(10) Pub. No.: US 2026/0176991 A1
(43) Pub. Date: Jun. 25, 2026

(54) CYLINDER DEACTIVATION SYSTEM

(71) Applicant: Eaton Intelligent Power Limited, Dublin (IE)

(72) Inventor: Nicola Andrisani, Turin (IT)

(21) Appl. No.: 19/544,822

(22) Filed: Feb. 19, 2026

Related U.S. Application Data
(63) Continuation of application No. PCT/IB2024/059501, filed on Sep. 27, 2024.
(60) Provisional application No. 63/586,010, filed on Sep. 28, 2023.

(51) Int. Cl. F01L 13/00; F01L 1/18; F02D 13/06; F02D 41/00

(52) U.S. Cl. CPC F01L 13/0005; F01L 1/18; F02D 13/06; F02D 41/0087; F01L 2013/001; F01L 2201/00

(57) ABSTRACT

A valvetrain system may include a rocker arm assembly actuatable between a drive mode defining a drive valve lift profile of an engine valve, and a cylinder deactivation mode defining a recharge valve lift profile of the engine valve. The recharge valve lift profile begins after the drive valve lift profile. The recharge valve lift profile defines a recharge lift amplitude that is less than a drive lift amplitude. The recharge valve lift profile ends within 15% of an end of the drive valve lift profile. The recharge valve lift profile is defined entirely within the drive valve lift profile so that: when the rocker arm assembly is in the drive mode, movement of the engine valve is dictated by the drive valve lift profile, and when the rocker arm assembly is in the cylinder deactivation mode, movement of the engine valve is dictated by the recharge valve lift profile.

### CROSS-REFERENCE TO RELATED APPLICATIONS

This application claims the benefit under 35 U.S.C. § 365(c) of International Patent Application No. PCT/IB2024/059501, filed 27 September 2024, which claims the benefit under 35 U.S.C. § 119(e) of U.S. Provisional Patent Application No. 63/586,010 filed on 28 September 2023, which are incorporated herein by reference.

### BACKGROUND

This disclosure relates to engines and engine valvetrain systems. More particularly, this disclosure relates to cylinder deactivation systems for engine valvetrain systems.

### SUMMARY

In some aspects, the techniques described herein relate to a valvetrain system including: a rocker arm assembly actuatable between a drive mode defining a drive valve lift profile of an engine valve, and a cylinder deactivation mode defining a recharge valve lift profile of the engine valve, wherein the recharge valve lift profile begins after the drive valve lift profile, wherein the recharge valve lift profile defines a recharge lift amplitude that is less than a drive lift amplitude, wherein the recharge valve lift profile ends within 15% of an end of the drive valve lift profile, and wherein the recharge valve lift profile is defined entirely within the drive valve lift profile so that: when the rocker arm assembly is in the drive mode, movement of the engine valve is dictated by the drive valve lift profile, and when the rocker arm assembly is in the cylinder deactivation mode, movement of the engine valve is dictated by the recharge valve lift profile.

In some aspects, the techniques described herein relate to a valvetrain system, wherein the recharge valve lift profile starts opening after the drive valve lift profile.

In some aspects, the techniques described herein relate to a valvetrain system, wherein the recharge valve lift profile defines a recharge valve lift duration that is shorter than a drive valve lift duration.

In some aspects, the techniques described herein relate to a valvetrain system, wherein the recharge valve lift profile starts after 25% of the drive valve lift duration has passed.

In some aspects, the techniques described herein relate to a valvetrain system, wherein the recharge valve lift profile starts after 40% to 75% of the drive valve lift duration has passed.

In some aspects, the techniques described herein relate to a valvetrain system, wherein the recharge valve lift duration is 25% to 75% of the drive valve lift duration.

In some aspects, the techniques described herein relate to a valvetrain system, wherein the recharge valve lift duration is less than 60% of the drive valve lift duration.

In some aspects, the techniques described herein relate to a valvetrain system, wherein the recharge lift amplitude is less than 60% of the drive lift amplitude.

In some aspects, the techniques described herein relate to a valvetrain system, wherein the recharge valve lift profile ends before the drive valve lift profile.

In some aspects, the techniques described herein relate to a valvetrain system, wherein the recharge valve lift profile ends within 10% of the end of the drive valve lift profile.

In some aspects, the techniques described herein relate to a valvetrain system, wherein the recharge valve lift profile ends within 5% of the end of the drive valve lift profile.

In some aspects, the techniques described herein relate to a valvetrain system, further including: the engine valve including an intake valve, wherein the drive valve lift profile and the recharge valve lift profile are applied to the intake valve by a valve portion of the rocker arm assembly.

In some aspects, the techniques described herein relate to a valvetrain system, further including: a drive cam that defines the drive valve lift profile; and a recharge cam that defines the recharge valve lift profile.

In some aspects, the techniques described herein relate to a valvetrain system, wherein the rocker arm assembly further includes: a latch assembly; and a controller, wherein the controller includes at least one processor, and memory having instructions stored thereon that, when executed by the at least one processor, cause the controller to: receive a cylinder deactivation signal; and control the latch assembly to disengage the drive cam and implement the cylinder deactivation mode in response to receiving the cylinder deactivation signal.

In some aspects, the techniques described herein relate to a valvetrain system, wherein the recharge cam does not engage the rocker arm assembly when the drive mode is active.

In some aspects, the techniques described herein relate to an engine including: a plurality of cylinders, each cylinder including a rocker arm assembly actuatable between a drive mode defining a drive valve lift profile, and a cylinder deactivation mode defining a recharge valve lift profile, wherein the recharge valve lift profile begins after the drive valve lift profile, wherein the recharge valve lift profile defines a recharge lift amplitude that is less than a drive lift amplitude, wherein the recharge valve lift profile ends within 15% of an end of the drive valve lift profile, and wherein the recharge valve lift profile is defined entirely within the drive valve lift profile; and a controller, wherein the controller includes at least one processor, and memory having instructions stored thereon that, when executed by the at least one processor, cause the controller to: receive a cylinder deactivation signal; and activate the cylinder deactivation mode in at least one cylinder in response to receiving the cylinder deactivation signal.

In some aspects, the techniques described herein relate to an engine, wherein the cylinder deactivation signal includes an identification of which cylinders to operate in the cylinder deactivation mode.

In some aspects, the techniques described herein relate to an engine, wherein the recharge valve lift profile starts opening after the drive valve lift profile, wherein the recharge valve lift profile defines a recharge valve lift duration that less than 60% of a drive valve lift duration, wherein the recharge lift amplitude is less than 60% of the drive lift amplitude, and wherein the recharge valve lift profile ends before the drive valve lift profile.

In some aspects, the techniques described herein relate to a rocker arm assembly actuatable between a drive mode defining a drive valve lift profile, and a cylinder deactivation mode defining a recharge valve lift profile, wherein the recharge valve lift profile starts opening after the drive valve lift profile, wherein the recharge valve lift profile defines a recharge valve lift duration that less than 60% of a drive valve lift duration, wherein a recharge lift amplitude is less than 60% of a drive lift amplitude, and wherein the recharge valve lift profile ends before the drive valve lift profile

In some aspects, the techniques described herein relate to a rocker arm assembly, wherein the recharge valve lift profile starts after 25% of the drive valve lift duration has passed, and wherein the recharge valve lift profile ends within 10% of an end of the drive valve lift profile.

This summary is illustrative only and is not intended to be in any way limiting. Other aspects, features, and advantages of the devices or processes described herein will become apparent in the detailed description set forth herein, taken in conjunction with the accompanying figures, wherein like reference numerals refer to like elements.

### BRIEF DESCRIPTION OF DRAWINGS

The device is explained in even greater detail in the following drawings. The drawings are merely exemplary and certain features may be used singularly or in combination with other features. The drawings are not necessarily drawn to scale.

FIG. 1 is a schematic representation of an engine, according to some implementations.

FIG. 2 is a perspective view of a rocker arm assembly, according to some implementations.

FIG. 3 is a perspective view of the rocker arm assembly of FIG. 2, according to some implementations.

FIG. 4 is a sectional rear view of the rocker arm assembly of FIG. 2, according to some implementations.

FIG. 5 is a schematic representation of a controller of the engine of FIG. 1, according to some implementations.

FIG. 6 is a graph showing an active drive valve lift profile and a cylinder deactivation valve lift profile, according to some implementations.

FIG. 7 is a graph showing an inactive drive valve lift profile and a cylinder deactivation valve lift profile, according to some implementations.

### DETAILED DESCRIPTION

Following below are more detailed descriptions of concepts related to, and implementations of, methods, apparatuses, and systems for an engine, a valvetrain system, and a rocker arm assembly. The figures illustrate exemplary implementations in detail and the present disclosure is not limited to the details or methodology set forth in the description or illustrated in the figures. The terminology used herein is for the purpose of description only and should not be regarded as limiting.

Referring to the figures generally, the various implementations disclosed herein relate to systems, apparatuses, and methods for an auxiliary valve actuation mechanism installed on at least one valve (e.g., an intake valve) and driven by an auxiliary cam lobe having a secondary lift profile designed to stay inside the main valve lift profile. When the cylinder is in a cylinder deactivation (CDA) mode, the main valve lift is deactivated and the main valve lift profile is bypassed. During operation in the CDA mode, the auxiliary valve actuation mechanism causes the intake valve to keep opening and closing following the secondary valve lift profile. The secondary lift profile defines less lift and a shorter lift than the main valve lift profile. The secondary lift profile provides refresh air into the cylinder so that a consistent volume of air is introduced to the cylinder on every stroke. The secondary lift profile maintains a consistent spring rate within the cylinder during operation in the CDA mode. The secondary lift profile inhibits the intrusion of lubricating oil into the cylinder past the piston rings during operation in the CDA mode.

CDA in engines can provide benefits such as improved overall efficiencies, fuel economy, and aftertreatment performance at low loads. Valvetrain systems can be adapted to selectively deactivate one or more cylinders in an engine. In some implementations, CDA is applied by shutting off valve motion. However, stopping valve motion may incur particular disadvantages for engine performance. For example, a lack of cylinder pressure management during operation in a CDA mode may be associated with harmful low gas temperatures, lubrication system contamination, and/or reduced emission control. It can therefore be desirable to provide systems and methods for improving cylinder pressure management in the CDA mode.

In some implementations, the CDA mode is applied to an internal combustion engine to help improve performance (e.g., for fuel savings, for increasing exhaust temperature, aftertreatment thermal management, etc.). During operation in the CDA mode, gas is trapped inside the engine cylinder. In typical CDA systems, a pressure of the gas trapped within an engine cylinder dissipates because of leakage (e.g., air passing by the piston rings). Eventually, a negative pressure develops in the cylinder (e.g., when a piston is near to bottom dead center), which can lead to unwanted oil leak or intrusion into a combustion chamber defined by the cylinder and the piston from the oil sump. Oil intrusion can lead to an elevated pressure in the cylinder when at top dead center and will be burned when the CDA mode is discontinued and normal internal combustion resumes, leading to dirty combustion.

For example, in typical engines, gas trapped within the combustion chamber 36 during operation with CDA may drive or incur blow-by of trapped gas into a crankcase, undesirable heat transfer, and/or may lead to gas energy dissipation resulting in pressure decays and gas temperature drop. Negative pressure gradient within the combustion chamber of typical engines relative to the crankcase may lead to an unwanted oil leak. Separately or additionally, low gas temperature may be harmful in terms of emissions, and in extreme cases, may be associated with formation of crystals from vapors. These phenomena can be more pronounced when CDA vacuum strategies are applied, such as by deactivating intake valves before deactivating exhaust valves. Therefore, CDA recharging where some air is allowed to refill the cylinder can be beneficial, such as by providing relatively small valve opening event(s) during the CDA mode. The CDA mode can recharge a combustion chamber and provide pressure balancing and/or rebalancing during engine operation with the CDA mode enabled.

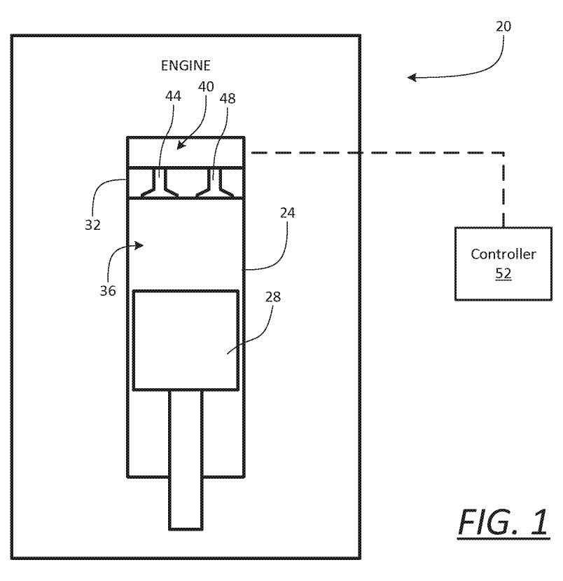

As shown in FIG. 1, an engine 20 includes a cylinder 24, a piston 28 sized to fit within the cylinder 24, a head 32 enclosing the cylinder 24, and a combustion chamber 36 defined between the cylinder 24, the piston 28 and the head 32. A valvetrain system 40 includes an intake valve 44 and an exhaust valve 48. A controller 52 is arranged in communication with the valvetrain system 40 and structured to control operation of the valvetrain system 40. The engine 20 includes multiple cylinders 24, though only one is shown. In some implementations, the engine 20 is a six-cylinder engine, includes more than six cylinders 24 or less than six cylinders 24. The following description will reference a single cylinder 24 and it is to be understood that the description can relate to any number of cylinders 24 of the engine 20. The engine 20 is an internal combustion engine such as a spark ignition engine or a compression ignition engine.

In some implementations, the controller 52 is structured to selectively implement the CDA mode. In some implementations, when the CDA mode is enabled during engine operation, gas (e.g., air) trapped inside the cylinder 24 may consume work and/or dissipate energy.

In some implementations, the valvetrain system 40 includes a rocker arm assembly that allows implementation of the CDA mode. While this disclosure may describe particular kinds of valvetrain architectures and/or switchable rocker arm designs to provide a better understanding, it will be appreciated that this disclosure contemplates any suitable valvetrain architecture and/or switchable rocker arm design for implementing the CDA mode. By way of example and not limitation, systems and methods described herein may be adapted to any suitable valvetrain architecture, such as Types I through V, and any such variations are fully contemplated herein in any suitable combination.

Systems and methods described herein may be adapted to many kinds of switching mechanisms and/or actuation methods for implementing switchable rocker arm systems and/or switchable lost motion mechanisms. In some implementations, hydraulically driven actuation systems described herein by way of non-limiting example may be complemented or replaced by electrically or electromagnetically driven actuation systems, such as using solenoids. In some implementations, valve lift profiles may be directly transferred to a rocker arm assembly from a cam, such as via a roller mechanism. In some implementations, valve lift profiles may be indirectly transferred to a rocker arm assembly, such as via a pushrod mechanism, and/or via a hydraulic lash adjuster or other mechanism.

By way of example and not limitation, collapsible and/or extendable systems, capsule based systems, and/or other lost motion mechanisms with or without springs may employed. By way of example and not limitation, latch mechanisms comprising one or more pins may be employed. In some implementations, one or more pins of the latch mechanism employed herein may be respectively biased along one or more directions.

In some implementations, systems and methods of switchable and/or deactivating rocker arm assemblies are disclosed that may allow opening of one or more valve(s) for recharging when the CDA mode is enabled. In some implementations, one or more valves are operable for the CDA mode may be intake valves (e.g., the intake valve 44), or exhaust valves (e.g., the exhaust valve 48), or a combination thereof. In some implementations, as will be further described herein, when an operational mode such as a drive mode is enabled that comprises disablement of cylinder deactivation (i.e., does not include the CDA mode), a standard or drive valve lift may be translated by a rocker arm assembly from a drive cam to one or more valves for providing a drive mode operation without cylinder activation. In contrast, in some implementations, when the CDA mode is enabled, the standard or drive valve event may be eliminated, and instead a recharging valve lift may be translated by the rocker arm assembly from a recharge cam to one or more valve for providing a cylinder activation mode with recharging.

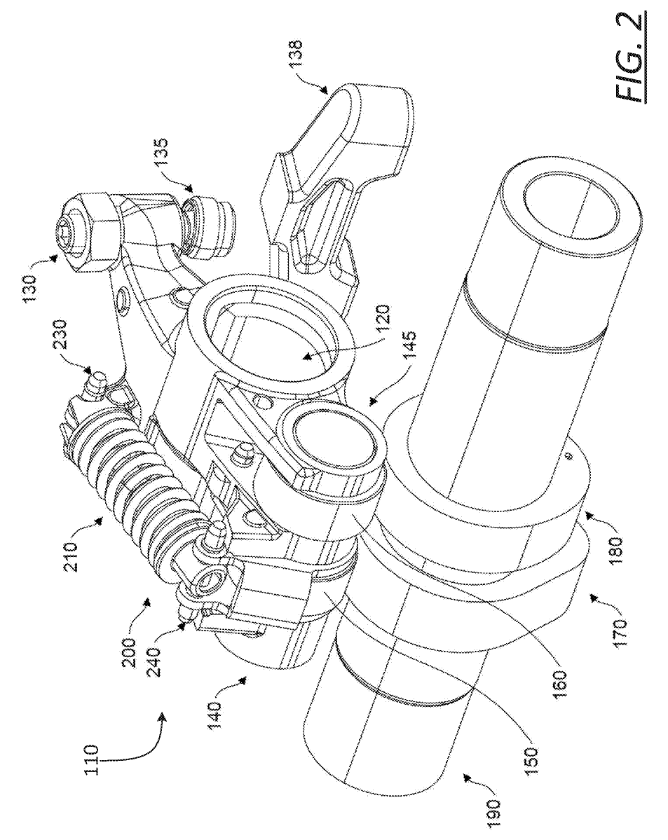

As shown in FIG. 2, a rocker arm assembly 110 rotates about a rocker shaft passing through a rocker shaft bore 120. In some implementations, the rocker arm assembly 110 includes a valve portion 130 that engages one or more valves (e.g., the intake valve 44) of the cylinder 24. In some implementations, the valve portion 130 includes a suitable interfacing structure for directly or indirectly engaging the intake valve 44, such as an E-foot 135. In some implementations, the valve portion 130 engages a plurality of valves, such as via a valve bridge 138. In some implementations, the valve portion 130 may comprise one or more switchable assemblies, such as a collapsible and/or extendable capsule assembly.

In some implementations, the rocker arm assembly 110 may comprise a rocker arm portion configured to receive one or more valve lift profiles, such as directly or indirectly from one or more cams. In some implementations, the rocker arm portion includes a drive cam portion 140 including a drive roller 150 that is directly engageable with a drive cam 170. In some implementations, the rocker arm portion also includes a recharge cam portion 145 including a recharge roller 160 that is directly engageable with a recharge cam 180. In some implementations, the drive cam 170 and the recharge cam 180 are provided a camshaft 190. In some implementations, separate cams configured to interface with rocker arm assembly 110 may be disposed on separate camshafts. In some implementations, the recharge cam portion 145 is rigidly coupled to the valve portion 130 such that they rotate as an integral unit about a rocker shaft of the valvetrain system 40.

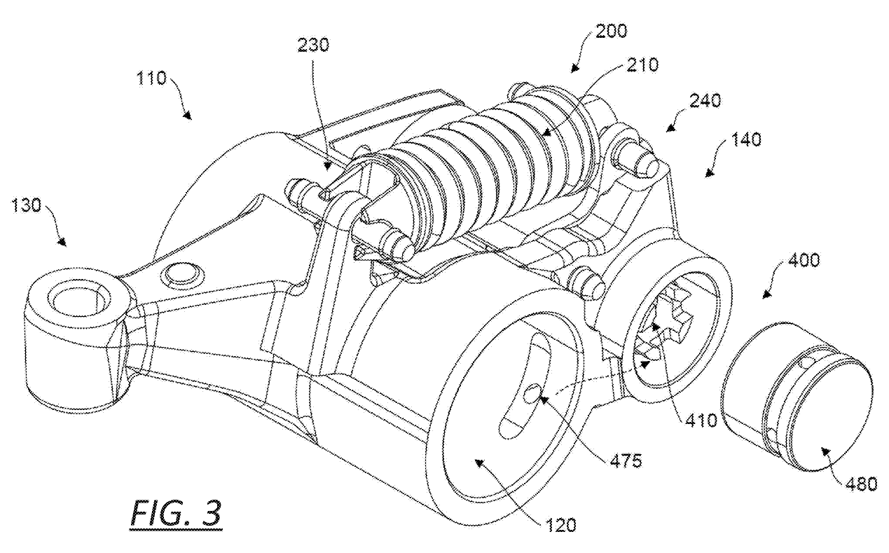

As shown in FIG. 3, the rocker arm assembly 110 includes switchable mechanisms that selectively transmit, modify, and/or absorb one or more portions of one or more valve lift profiles received by rocker arm assembly 110 (e.g., the via the drive cam 170 and/or the recharge cam 180). For example, the drive cam portion 140 of rocker arm assembly 110 includes a lost motion assembly 200 and a switchable latch assembly 400. In some implementations, the latch assembly 400 may be hydraulically actuated, such as based on receiving a pressurized hydraulic fluid. Separately or additionally, in some implementations, the latch assembly 400 may be electrically or electromagnetically actuated, such as by a solenoid.

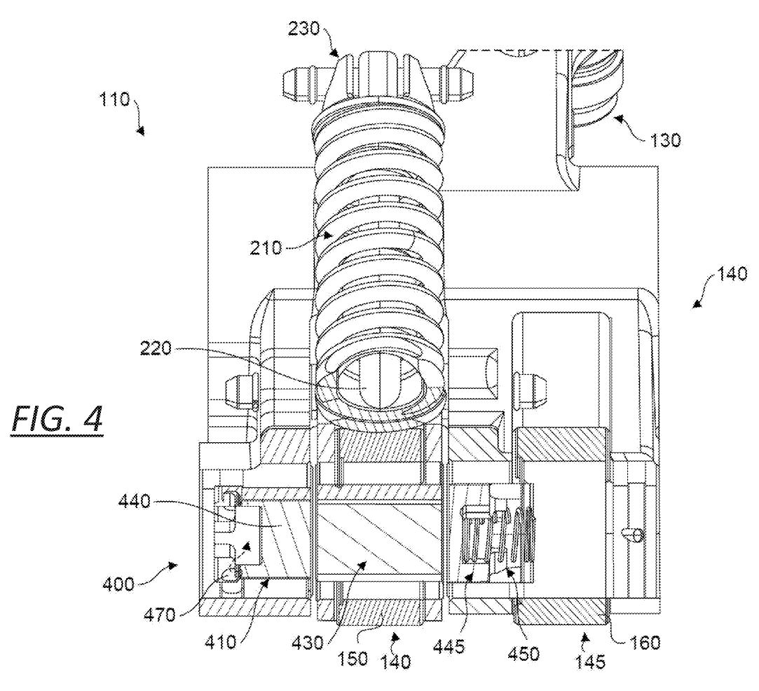

In some implementations, the lost motion assembly 200 includes one or more systems configured for absorbing displacement and/or motion. For example, the lost motion mechanism 200 includes a lost motion spring 210 capable of absorbing valve lift received from drive cam 170, such as by compressing based on receiving force, displacement, and/or energy associated with a valve lift from a cam. In some implementations, the lost motion spring 210 is supported by a lost motion support member 220 (see FIG. 4). In some implementations, the lost motion mechanism 200 is secured to and/or supported by one or more connection assemblies connected to other portions of rocker arm assembly 110. In some implementations, a first connection 230 connects the lost motion mechanism 200 to the valve portion 130. In some implementations, a second connection 240 connects the lost motion mechanism 200 to the drive cam portion 140. While particular features of specific lost motion mechanisms (e.g., the lost motion mechanism 200) are described and/or illustrated herein to provide a better understanding, other suitable forms and features of switchable mechanisms are fully contemplated in this disclosure. By way of example and not limitation, a switchable assembly to selectively enable or disable operation of lost motion mechanism 200 may be disposed and/or combined with lost motion mechanism 200.

As shown in FIG. 4, the latch assembly 400 selectively couples the drive cam portion 140 to transmit a drive valve lift profile received from drive cam 170 to valve portion 130, and/or so that drive cam portion 140 may rotate integral with the remaining rocker arm assembly 110 about a rocker shaft. In some implementations, accordingly, latch assembly 400 decouples the drive cam portion 140 such that, for example, lost motion mechanism 200 may absorb a drive valve lift profile received by drive cam portion 140 from drive cam 170 and/or otherwise prevent transmitting the received drive valve lift to valve portion 130 of rocker arm assembly 110.

In some implementations, the latch assembly 400 includes a latch bore 410 having a plurality of bore portions disposed across multiple portions of rocker arm assembly 110. In some implementations, the latch bore 410 is at least partially disposed in drive roller 150 of drive cam portion 140. In some implementations, one or more latch pins of latch assembly 400 are latchable or unlatchable to selectively transmit a drive valve lift profile received from drive cam 170 to valve portion 130 of rocker arm assembly 110. In some implementations, one or more latch pins, such as latch pin 430, are slidably disposed in latch bore 410 such that axial motion along the latch bore 410 may rotatably couple or decouple drive cam portion 140 to rotate relative to valve portion 130, for example, about a rocker shaft disposed in rocker shaft bore 120. In some implementations, to enable selective latching by latch assembly 400, one or more latch pins selectively slides into, protrudes into, and/or out of a portion of latch bore 410 disposed in drive cam portion 140. In some implementations, one or more axial ends of latch bore 410 includes a biasing member 450 and a support pin 445.

In some implementations, actuation of the latch assembly 400 is based on differential action based on relative forces applied from a plurality of sides. For example, a piston 440 is axially movable to the right (in the frame of reference of FIG. 4) when actuated or energized, and/or that is axially restored to the left when de-actuated or de-energized based on a restoring force applied by the biasing member 450. In some implementations, the piston 440 is selectively movable or translatable based on selectively pressurizing a chamber, such as with hydraulic fluid fed through a hydraulic bore 470. In some implementations, with a hydraulic chamber end cap 480 removed, the hydraulic bore 470 may be fluidly connected to a controllable pressurized hydraulic fluid source via a hydraulic channel 475. In some implementations, a solenoid-based oil control valve (OCV) may be used to selectively pressurize a hydraulic line to the latch assembly 400, such as via the rocker shaft bore 120.

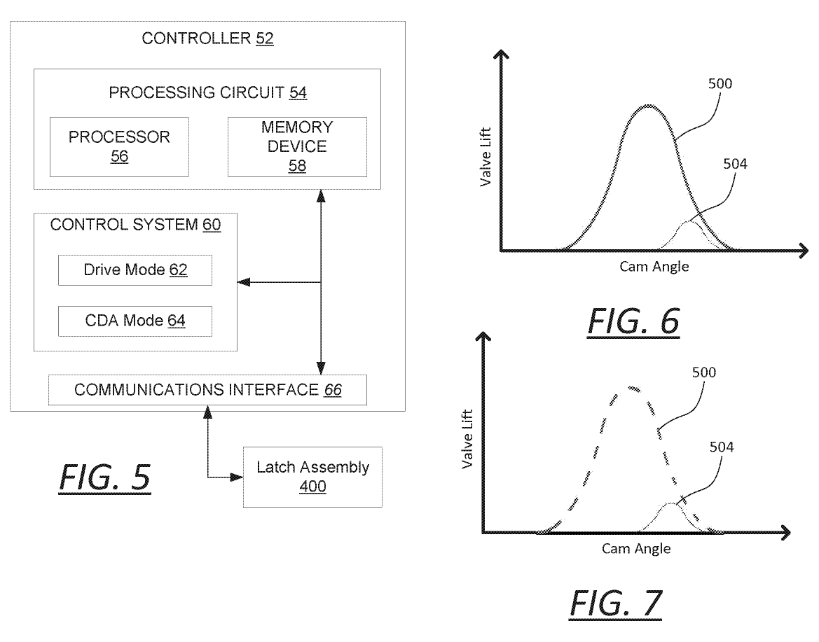

Referring now to FIG. 5, a schematic diagram of the controller 52 is shown according to an example implementation. As shown in FIG. 5, the controller 52 includes a processing circuit 54 having a processor 56 and a memory device 58, a control system 60 having a drive mode circuit 62 and a CDA mode circuit 64, and a communications interface 66. Generally, the controller 52 is structured to operate the cylinder 24 of the engine 20 in a drive mode and in a CDA mode. In some implementations, the controller 52 is structured to determine when to implement the CDA mode and on how many cylinders 24 of the engine 20. In some implementations, the recharge roller 160 is always engaged with the recharge cam 180 and the controller 52 selectively implements the drive mode by engaging the drive roller 150 with the drive cam 170. In other words, when the drive roller 150 is actuated to not engage the drive cam 170, the CDA mode is active and the cylinder 24 is deactivated. In some implementations, the controller 52 is a engine control unit (ECU) or another vehicle controller.

In one configuration, the circuits of the control system 60 are in the form of machine or computer-readable media that is executable by a processor, such as processor 56. The machine-readable media facilitates performance of operations to enable reception and transmission of data. For example, the machine-readable media may provide an instruction (e.g., command, etc.) to acquire data. The computer readable program code may be executed on one processor, multiple co located processors, multiple remote processors, or any combination of local and remote processors. Remote processors may be connected to each other through any type of network (e.g., CAN bus, etc.).

In another configuration, the circuits of the control system 60 are implemented as hardware units, such as electronic control units. As such, the circuits of the control system 60 may be implemented as one or more circuitry components including, but not limited to, processing circuitry, network interfaces, peripheral devices, input devices, output devices, sensors, etc. In some implementations, the circuits of the control system 60 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The circuits of the control system 60 may also include programmable hardware devices such as field programmable gate arrays, programmable array logic, programmable logic devices or the like. The circuits of the control system 60 may include one or more memory devices for storing instructions that are executable by the processor(s) of the circuits of the control system 60. In some hardware unit configurations, the circuits of the control system 60 may be geographically dispersed throughout separate locations. Alternatively and as shown, the circuits of the control system 60 may be implemented in or within a single unit/housing, which is shown as the controller 52.

In the example shown, the controller 52 includes the processing circuit 54 having the processor 56 and the memory device 58. The processing circuit 54 may be structured or configured to execute or implement the instructions, commands, and/or control processes described herein with respect to the circuits of the control system 60. The depicted configuration represents the circuits of the control system 60 as machine or computer-readable media. However, as mentioned above, this illustration is not meant to be limiting as the present disclosure contemplates other implementations where the circuits of the control system 60, or at least one circuit of the circuits of the control system 60, is configured as a hardware unit. All such combinations and variations are intended to fall within the scope of the present disclosure.

The hardware and data processing components used to implement the various processes, operations, illustrative logics, logical blocks, modules and circuits described in connection with the implementations disclosed herein (e.g., the processor 56) may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration.

The memory device 58 (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory device 58 may be communicably connected to the processor 56 to provide computer code or instructions to the processor 56 for executing at least some of the processes described herein. Moreover, the memory device 58 may be or include tangible, non-transient volatile memory or non-volatile memory. Accordingly, the memory device 58 may include database components, object code components, script components, or any other type of information structure for supporting the various activities and information structures described herein.

The drive mode circuit 62 is structured to receive a drive mode signal (e.g., in response to a demand for power requiring activation of the cylinder 24). The drive mode circuit 62 determines a drive valve lift profile based on receiving the drive mode signal. In some implementations, the drive valve lift profile is retrieved from a lookup table stored in the memory device 58. For example, the drive valve lift profile may be dependent on power or performance demands of the engine 20 and may be different depending on the requirements of the engine 20 (e.g., coordination with a spark timing circuit, requirements for increased efficiency, motoring conditions, etc.). In some implementations, the drive valve lift profile is determined within the drive mode circuit 62 or defines a constant profile. The drive mode circuit 62 is also structured to control the latch assembly 400 of the rocker arm assembly 110 via the communications interface 66. When the drive mode signal is received, the drive mode circuit 62 provides information to the latch assembly 400 so that the drive roller 150 is positioned in engagement with the drive cam 170 and the drive valve lift profile dictates the position if the valve (e.g., the intake valve 44). In some implementations, the drive mode is controlled by a different structure and the valve lifting mechanism is controlled by the drive mode circuit 62 to enable or disable the drive mode.

The CDA mode circuit 64 is structured to receive a CDA mode signal (e.g., in response to a demand for increased efficiency, a demand for increased exhaust temperature, etc.). The CDA mode circuit 64 is also structured to control the latch assembly 400 of the rocker arm assembly 110 via the communications interface 66. When the CDA mode signal is received, the CDA mode circuit 64 provides information to the latch assembly 400 so that the drive roller 150 is disengaged from the drive cam 170 and the valve portion 130 is not moved according to the drive valve lift profile. In some implementations, a recharge valve lift profile is defined by the recharge cam 180 and the recharge roller 160 is arranged in a constantly active relationship with the recharge cam 180 so that the recharge valve lift profile is always active, even when the drive mode is active. In some implementations, the CDA mode circuit 64 can control the recharge valve lift profile and a different valve control structure is used to control the valve (e.g., the intake valve 44) during CDA mode operation.

While various circuits with particular functionality are shown in FIG. 5, it should be understood that the controller 52 may include any number of circuits for completing the functions described herein. For example, the activities and functionalities of the circuits of the control system 60 may be combined in multiple circuits or as a single circuit. Additional circuits with additional functionality may also be included. Further, the controller 52 may further control other activity beyond the scope of the present disclosure.

As mentioned above and in one configuration, the “circuits” may be implemented in machine-readable medium for execution by various types of processors, such as the processor 56 of FIG. 5. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be implemented in any suitable form and organized within any suitable type of data structure. The operational data may be collected as a single data set, or may be distributed over different locations including over different storage devices, and may exist, at least partially, merely as electronic signals on a system or network.

As shown in FIG. 6, operation of the cylinder 24 in the drive mode includes active control via the drive mode circuit 62 so that the intake valve 44 is lifted according to a drive valve lift profile 500. A recharge valve lift profile 504 is defined entirely within the drive valve lift profile 500. In other words, when the drive mode is active, the drive roller 150 will be engaged with the drive cam 170 and the recharge roller 160 will not engage the recharge cam 180. The entirety of the movement of the valve (e.g., the intake valve 44) is dictated by the drive valve lift profile 500 (e.g., the shape of the drive cam 170).

As shown in FIG. 7, when the drive mode is disabled and the CDA mode is active, then the drive valve lift profile 500 is no longer (e.g., the latch assembly 400 disengages the drive roller 150 from the drive cam 170). With the drive valve lift profile 500 inactive, the recharge cam 180 engages the recharge roller 160 and the recharge valve lift profile 504 is active and dictates the movement of the valve (e.g., the intake valve 44).

In some implementations, the recharge valve lift profile 504 starts opening after the drive valve lift profile 500 as the cam angle increases. In some implementations, the recharge valve lift profile 504 starts after 25% of a drive valve lift duration has passed. In some implementations, the recharge valve lift profile 504 starts after 40% to 75% of the drive valve lift duration has passed.

In some implementations, the recharge valve lift profile 504 defines a recharge valve lift duration that is shorter than the drive valve lift duration. In some implementations, the recharge valve lift duration is 25% to 75% of the drive valve lift duration. In some implementations, the recharge valve lift duration is less than 60% of the drive valve lift duration. In some implementations, the recharge valve lift duration is less than 50% of the drive valve lift duration.

In some implementations, the recharge valve lift profile 504 defines a recharge lift amplitude that is less than a drive lift amplitude of the drive valve lift profile 500. In some implementations, the recharge lift amplitude is less than 60% of the drive lift amplitude. In some implementations, the recharge lift amplitude is less than 50% of the drive lift amplitude. In some implementations, the recharge lift amplitude is less than 25% of the drive lift amplitude.

In some implementations, the recharge valve lift profile 504 ends before the drive valve lift profile 500. In some implementations, the recharge valve lift profile 504 ends within 5% of the end of the drive valve lift profile 500. In some implementations, the recharge valve lift profile 504 ends within 10% of the end of the drive valve lift profile 500. In some implementations, the recharge valve lift profile 504 ends within 15% of the end of the drive valve lift profile 500.

In some implementations, the recharge valve lift profile 504 is defined entirely within the drive valve lift profile 500. In other words, the entire recharge valve lift profile 504 is defined inside the drive valve lift profile 500.

It will be appreciated that the form of the drive valve lift profile 500 and/or the recharge valve lift profile 504 depicted in FIGS. 6 and 7 are non-limiting and schematic, and are included for providing a better understanding. By way of example and not limitation, either or both of drive the valve lift profile 500 or the recharge valve lift profile 504 may comprise different shapes (e.g., having multiple peaks), and/or may be positioned differently along the valve lift or cam angle axes. Such and other variations are fully contemplated by this disclosure.

For purposes of this description, certain advantages and novel features of the aspects and configurations of this disclosure are described herein. The described methods, systems, and apparatus should not be construed as limiting in any way. Instead, the present disclosure is directed toward all novel and nonobvious features and aspects of the various disclosed aspects, alone and in various combinations and sub-combinations with one another. The disclosed methods, systems, and apparatus are not limited to any specific aspect, feature, or combination thereof, nor do the disclosed methods, systems, and apparatus require that any one or more specific advantages be present or problems be solved.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Features disclosed in this specification (including any accompanying claims, abstract, and drawings), and/or all of the steps of any method or process so disclosed, may be combined in any combination, except combinations where at least some of such features and/or steps are mutually exclusive. The claimed features extend to any novel one, or any novel combination, of the features disclosed in this specification (including any accompanying claims, abstract, and drawings), or to any novel one, or any novel combination, of the steps of any method or process so disclosed.

As used in the specification and the appended claims, the singular forms “a”, “an”, and “the” include plural referents unless the context clearly dictates otherwise. Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about”, it will be understood that the particular value forms another aspect. It will be further understood that the endpoints of each of the ranges are significant both in relation to the other endpoint, and independently of the other endpoint. The terms “about” and “approximately” are defined as being “close to” as understood by one of ordinary skill in the art. In one non-limiting aspect the terms are defined to be within 10%. In another non-limiting aspect, the terms are defined to be within 5%. In still another non-limiting aspect, the terms are defined to be within 1%.

The terms “coupled”, “connected”, and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

Certain terminology is used in the following description for convenience only and is not limiting. The words “right”, “left”, “lower”, and “upper” designate direction in the drawings to which reference is made. The words “inner” and “outer” refer to directions toward and away from, respectively, the geometric center of the described feature or device. The words “distal” and “proximal” refer to directions taken in context of the item described and, with regard to the instruments herein described, are typically based on the perspective of the practitioner using such instrument, with “proximal” indicating a position closer to the practitioner and “distal” indicating a position further from the practitioner. The terminology includes the above-listed words, derivatives thereof, and words of similar import.

Throughout the description and claims of this specification, the word “comprise” and variations of the word, such as “comprising” and “comprises”, means “including but not limited to”, and is not intended to exclude, for example, other additives, components, integers or steps.

“Exemplary” means “an example of” and is not intended to convey an indication of a preferred or ideal aspect. “Such as” is not used in a restrictive sense, but for explanatory purposes.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the form disclosed. Many modifications and variations will be apparent to those of ordinary skill in the art without departing from the scope and spirit of the present disclosure.

What is claimed is:

1. A valvetrain system comprising:
a rocker arm assembly actuatable between a drive mode and a cylinder deactivation mode, the rocker arm assembly having (i) a drive cam portion for receiving a drive valve lift profile defined by a drive cam and (ii) a recharge cam portion for receiving a recharge valve lift profile defined by a recharge cam; and
a latch assembly disposed in the rocker arm assembly and configured to selectively (i) couple the drive cam portion so as to enable transmission of the drive valve lift profile to an engine valve and (ii) decouple the drive cam portion so as to prevent transmission of the drive valve lift profile to the engine valve;
wherein the recharge valve lift profile begins after the drive valve lift profile,
wherein the recharge valve lift profile defines a recharge lift amplitude that is less than a drive lift amplitude, and
wherein the recharge valve lift profile is defined entirely within the drive valve lift profile so that:
when the rocker arm assembly is in the drive mode, the latch assembly couples the drive cam portion so that movement of the engine valve is dictated by the drive valve lift profile, and
when the rocker arm assembly is in the cylinder deactivation mode, the latch assembly decouples the drive cam portion so that movement of the engine valve is dictated by the recharge valve lift profile.

2. The valvetrain system of claim 1, wherein the recharge valve lift profile starts opening after the drive valve lift profile.

3. The valvetrain system of claim 1, wherein the recharge valve lift profile defines a recharge valve lift duration that is shorter than a drive valve lift duration.

4. The valvetrain system of claim 3, wherein the recharge valve lift profile starts after 25% of the drive valve lift duration has passed.

5. The valvetrain system of claim 3, wherein the recharge valve lift profile starts after 40% to 75% of the drive valve lift duration has passed.

6. The valvetrain system of claim 3, wherein the recharge valve lift duration is 25% to 75% of the drive valve lift duration.

7. The valvetrain system of claim 3, wherein the recharge valve lift duration is less than 60% of the drive valve lift duration.

8. The valvetrain system of claim 1, wherein the recharge lift amplitude is less than 60% of the drive lift amplitude.

9. The valvetrain system of claim 1, wherein the recharge valve lift profile ends before the drive valve lift profile.

10. The valvetrain system of claim 1, wherein the recharge valve lift profile ends within 10% of the end of the drive valve lift profile.

11. The valvetrain system of claim 1, wherein the recharge valve lift profile ends within 5% of the end of the drive valve lift profile.

12. The valvetrain system of claim 1, further comprising:
the engine valve including an intake valve, wherein the drive valve lift profile and the recharge valve lift profile are applied to the intake valve by a valve portion of the rocker arm assembly.

13. The valvetrain system of claim 1, wherein the latch assembly comprises:
a latch bore at least partially disposed in a drive roller of the drive cam portion;
a latch pin configured to enable selective latching of the latch assembly, the latch pin being configured to selectively slide into or out of a portion of the latch bore disposed in the drive roller of the drive cam portion;
a support pin biased by a biasing member disposed in an axial end of the latch bore; and
a piston configured to actuate the latch assembly, the piston being axially movable when actuated and axially restored when de-actuated based on a restoring force applied by the biasing member.

14. The valvetrain system of claim 13, wherein the rocker arm assembly further includes:
a controller, wherein the controller comprises at least one processor, and memory having instructions stored thereon that, when executed by the at least one processor, cause the controller to:
receive a cylinder deactivation signal; and
control the latch assembly to decouple the drive cam portion so as to disengage the drive cam and implement the cylinder deactivation mode in response to receiving the cylinder deactivation signal.

15. The valvetrain system of claim 13, wherein the recharge cam portion is rigidly coupled to a valve portion of the rocker arm assembly.

16. An engine comprising:
a plurality of cylinders, each cylinder including
a rocker arm assembly actuatable between a drive mode and a cylinder deactivation mode, the rocker arm assembly having (i) a drive cam portion for receiving a drive valve lift profile defined by a drive cam and (ii) a recharge cam portion for receiving a recharge valve lift profile defined by a recharge cam; and
a latch assembly disposed in the rocker arm assembly and configured to selectively (i) couple the drive cam portion so as to enable transmission of the drive valve lift profile to an engine valve and (ii) decouple the drive cam portion so as to prevent transmission of the drive valve lift profile to the engine valve;
wherein the recharge valve lift profile begins after the drive valve lift profile,
wherein the recharge valve lift profile defines a recharge lift amplitude that is less than a drive lift amplitude, and
wherein the recharge valve lift profile is defined entirely within the drive valve lift profile; and
a controller, wherein the controller comprises at least one processor, and memory having instructions stored thereon that, when executed by the at least one processor, cause the controller to:
receive a cylinder deactivation signal; and
activate the cylinder deactivation mode in at least one cylinder in response to receiving the cylinder deactivation signal by controlling the latch assembly to decouple the drive cam portion.

17. The engine of claim 16, wherein the cylinder deactivation signal includes an identification of which cylinders to operate in the cylinder deactivation mode.

18. The engine of claim 16, wherein the recharge valve lift profile starts opening after the drive valve lift profile,
wherein the recharge valve lift profile defines a recharge valve lift duration that is less than 60% of a drive valve lift duration,
wherein the recharge lift amplitude is less than 60% of the drive lift amplitude, and
wherein the recharge valve lift profile ends before the drive valve lift profile.

19. A rocker arm assembly actuatable between a drive mode and a cylinder deactivation mode, the rocker arm assembly comprising:
a drive cam portion for receiving a drive valve lift profile defined by a drive cam;
a recharge cam portion for receiving a recharge valve lift profile defined by a recharge cam; and
a latch assembly disposed in the rocker arm assembly and configured to selectively (i) couple the drive cam portion so as to enable transmission of the drive valve lift profile to an engine valve and (ii) decouple the drive cam portion so as to prevent transmission of the drive valve lift profile to the engine valve;
wherein the recharge valve lift profile starts opening after the drive valve lift profile,
wherein the recharge valve lift profile defines a recharge valve lift duration that is less than 60% of a drive valve lift duration,
wherein a recharge lift amplitude is less than 60% of a drive lift amplitude, and
wherein the recharge valve lift profile ends before the drive valve lift profile.

20. The rocker arm assembly of claim 19, wherein the recharge valve lift profile starts after 25% of the drive valve lift duration has passed, and
wherein the recharge valve lift profile ends within 10% of an end of the drive valve lift profile.
